(19) United States
(12) Patent Application Publication
(10) Pub. No.: US 2019/0028731 A1
(43) Pub. Date: Jan. 24, 2019

(54) METHOD AND APPARATUS FOR AFFINE INTER PREDICTION FOR VIDEO CODING SYSTEM

(71) Applicant: MEDIATEK INC., Hsin-Chu (TW)

(72) Inventors: Tzu-Der CHUANG, Zhubei City, Hsinchu County (TW); Ching-Yeh CHEN, Taipei City (TW); Xiaozhong XU, State College, PA (US); Shan LIU, San Jose, CA (US)

(21) Appl. No.: 16/065,320

(22) PCT Filed: Jan. 6, 2017
(86) PCT No.: PCT/CN2017/070433

§ 371 Date: Jun. 22, 2018

Related U.S. Application Data
(60) Provisional application No. 62/288,490, filed on Jan. 29, 2016.
(60) Provisional application No. 62/275,817, filed on Jan. 7, 2016.

(51) Int. Cl. H04N 19/52; H04N 19/159; H04N 19/105; H04N 19/567; H04N 19/176

(52) U.S. Cl. CPC H04N 19/52; H04N 19/159; H04N 19/176; H04N 19/567; H04N 19/105

(57) ABSTRACT

Methods and apparatus of Inter prediction for video coding performed by a video encoder or a video decoder that utilizes motion vector prediction (MVP) to code a motion vector (MV) associated with a block coded with coding modes including affine Inter mode are disclosed. According to one method, MVP pairs for the current block are derived based on neighbouring blocks related to two control points for representing a 4-parameter affine motion model associated with the current block. A final MVP pair is selected based on two MVs for each MVP pair. In another method, MVP sets for three control points are derived to represent a 6-parameter affine motion model associated with the current block. A final MVP set is selected and included in the Inter candidate list. According to another method, one or more decoder-side derived MVs are included in a MVP set for inclusion in the Inter candidate list.

### CROSS REFERENCE TO RELATED APPLICATIONS

The present invention claims priority to U.S. Provisional Patent Application, Ser. No. 62/275,817, filed on Jan. 7, 2016 and U.S. Provisional Patent Application, Ser. No. 62/288,490, filed on Jan. 29, 2016.The U.S. Provisional Patent Applications are hereby incorporated by reference in their entireties.

### TECHNICAL FIELD

The present invention relates to video coding using motion estimation and motion compensation. In particular, the present invention relates to generating an Inter candidate list including one or more affine motion vector predictor (MVP) candidates associated with one or more blocks coded using the affine Inter mode.

### BACKGROUND

Various video coding standards have been developed over the past two decades. In newer coding standards, more powerful coding tools are used to improve the coding efficiency. High Efficiency Video Coding (HEVC) is a new coding standard that has been developed in recent years. In the High Efficiency Video Coding (HEVC) system, the fixed-size macroblock of H.264/AVC is replaced by a flexible block, named coding unit (CU). Pixels in the CU share the same coding parameters to improve coding efficiency. A CU may begin with a largest CU (LCU), which is also referred as coded tree unit (CTU) in HEVC. In addition to the concept of coding unit, the concept of prediction unit (PU) is also introduced in HEVC. Once the splitting of CU hierarchical tree is done, each leaf CU is further split into one or more prediction units (PUs) according to prediction type and PU partition.

In most coding standards, adaptive Inter/Intra prediction is used on a block basis. In the Inter prediction mode, one or two motion vectors are determined for each block to select one reference block (i.e., uni-prediction) or two reference blocks (i.e., bi-prediction). The motion vector or motion vectors are determined and coded for each individual block. For in HEVC, Inter motion compensation is supported in two different ways: explicit signalling or implicit signalling. In explicit signalling, the motion vector for a block (i.e., PU) is signalled using a predictive coding method. The motion vector predictors correspond to motion vectors associated with spatial and temporal neighbours of the current block. After a MV predictor is determined, the motion vector difference (MVD) is coded and transmitted. This mode is also referred as AMVP (advanced motion vector prediction) mode. In implicit signalling, one predictor from a candidate predictor set is selected as the motion vector for the current block (i.e., PU). Since both the encoder and decoder will derive the candidate set and select the final motion vector in the same way, there is no need to be signal the MV or MVD in the implicit mode. This mode is also referred as Merge mode. The forming of predictor set in Merge mode is also referred as Merge candidate list construction. An index, called Merge index, is signalled to indicate the predictor selected as the MV for current block.

Motion occurs across pictures along temporal axis can be described by a number of different models. Assuming A(x, y) be the original pixel at location (x, y) under consideration, A′ (x′, y′) be the corresponding pixel at location (x′, y′) in a reference picture for a current pixel A(x, y), some typical motion models are described as follows.

### Translational Model

The simplest one is the 2-D translational motion, where all the pixels in the area of interest follow the same motion direction and magnitude. This model can be described as follows, where a0 is the movement in the horizontal direction and b0 is the movement in the vertical direction:

x′=a0+x, and

y′=b0+y. (1)

In this model, two parameters (i.e., a0 and b0) are to be determined. Eq. (1) is true for all pixels (x, y) in the area of interest. Therefore, the motion vector for pixel A(x, y) and corresponding pixel A′(x′, y′) in this area is (a0, b0). FIG. 1 illustrates an example of motion compensation according to the translational model, where a current area 110 is mapped to a reference area 120 in a reference picture. The correspondences between the four corner pixels of the current area and the four corner pixels of the reference area are indicated by the four arrows.

Scaling Model

The scaling model includes the scaling effect in addition to the translational movement in the horizontal and vertical direction. The model can be described as follows:

x′=a0+a1*x, and

y′=b0+b1*y. (2)

According to this model, a total of four parameters are used, which include scaling factors a1 and b1 and translational movement values a0 and b0. For each pixel A(x, y) in the area of interest, the motion vector for this pixel and its corresponding reference pixel A′(x′, y′) is (a0+(a1-1)*x, b0+(b1-1)*y). Therefore, the motion vector for each pixel is location dependent. FIG. 2 illustrates an example of motion compensation according to the scaling model, where a current area 210 is mapped to a reference area 220 in a reference picture. The correspondences between the four corner pixels of the current area and the four corner pixels of the reference area are indicated by the four arrows.

Affine Model

The affine model is capable of describing two-dimensional block rotations as well as two-dimensional deformations to transform a square (or rectangles) into a parallelogram. This model can be described as follows:

x′=a0+a1*x+a2*y, and

y′=b0+b1*x+b2*y. (3)

In this model, a total of six parameters are used. For each pixels A(x, y) in the area of interest, the motion vector between this pixel and its corresponding reference pixel A′(x′, y′) is (a0+(a1−1)*x+a2*y, b0+b1*x+(b2 −1)*y). Therefore, the motion vector for each pixel is also location dependent. FIG. 3 illustrates an example of motion compensation according to the affine model, where a current area 310 is mapped to a reference area 320 in a reference picture. The affine transform can map any triangle to any triangle. In other words, the correspondences between the three corner pixels of the current area and the three corner pixels of the reference area can be determined by the three arrows as shown in FIG. 3. In this case, the motion vector for the fourth corner pixel can be derived in terms of the other three motion vectors instead of derived independently of the other three motion vectors. The six parameters for the affine model can be derived based on three known motion vectors for three different locations. Parameter derivation for the affine model is known in the field and the details are omitted here.

Various implementations of affine motion compensation have been disclosed in the literature. For example, an affine flag is signalled for 2N×2N block partition when the current block is coded either in the Merge mode or AMVP mode in a technical paper by Li el at. (“An Affine Motion Compensation Framework for High Efficiency Video Coding”, 2015 IEEE International Symposium on Circuits and Systems (ISCAS), May 2015, pages: 525-528). If this flag is true (i.e., affine mode), the derivation of motion vectors for the current block follows the affine model. If this flag is false (i.e., non-affine mode), the derivation of motion vectors for the current block follows the traditional translational model. Three control points (i.e., 3 MVs) are signalled when affine AMVP mode is used. At each control point location, the MV is predicatively coded. The MVDs of these control points are then coded and transmitted.

In another technical paper by Huang el at. (“Control-Point Representation and Differential Coding Affine-Motion Compensation”, IEEE Transactions on CSVT, Vol. 23, No. 10, pages 1651-1660, Oct. 2013), different control point locations and predictive coding of MVs in control points are disclosed. If Merge mode is used, the signalling of an affine flag is signalled conditionally, where the affine flag is only signalled when there is at least one Merge candidate being affine coded. Otherwise, this flag is inferred to be false. When the affine flag is true, the first available affine coded Merge candidate will be used for the affine Merge mode. Therefore there is no Merge index that needs to be signalled.

The affine motion compensation has been proposed to the future Video Coding being developed for standardization of future video coding technology under ITU-VCEG (Video Coding Experts Group) and ITU ISO/IEC JTC1/SC29/WG11. Joint Exploration Test Model 1 (JEM1) software has been established in October 2015 as a platform for collaborators to contribute proposed elements. The future standardization action could either take the form of additional extension(s) of HEVC or an entirely new standard.

One example syntax table for this implementation is shown in Table 1. As shown in Table 1, when Merge mode is used, a test regarding “whether at least one merge candidate is affine coded &&PartMode==PART_2N×2N)” is performed as indicated by Note (1-1). If the test result is true, an affine flag (i.e., use_affine_flag) is signalled as indicated by Note (1-2). When Inter prediction mode is used, a test regarding “whether log2CbSize>3 &&PartMode==PART_2N×2N” is performed as indicated by Note (1-3). If the test result is true, an affine flag (i.e., use_affine_flag) is signalled as indicated by Note (1-4). When the affine flag (i.e., use_affine_flag) has a value of 1 as indicated by Note (1-5), two more MVD's are signalled for the second and the third control MVs as indicated by Notes (1-6) and (1-7). For bi-prediction, similar signalling has to be done for L1 list as indicated by Notes (1-8) to (1-10).

TABLE 1

| | |
|---|---|
| prediction_unit( x0, y0, nPbW, nPbH ) { | Note |
| if( cu_skip_flag[ x0 ][ y0 ] ) { | |
| if( MaxNumMergeCand >1 ) | |
| merge_idx[ x0 ][ y0 ] | |
| } else { /* MODE_INTER */ | |
| merge_flag[ x0 ][ y0 ] | |
| if( merge_flag[ x0 ][ y0 ] ) { | |
| if( at least one merge candidate is affine coded &&PartMode = = PART_2Nx2N) | 1-1 |
| use_affine_flag | 1-2 |
| else | |
| if( MaxNumMergeCand > 1 ) | |
| merge_idx[ x0 ][ y0 ] | |
| } else { | |
| if( slice_type = = B ) | |
| inter_pred_idc[ x0 ][ y0 ] | |
| if( log2CbSize > 3 &&PartMode = = PART_2Nx2N) | 1-3 |
| use_affine_flag | 1-4 |
| if( inter_pred_idc[ x0 ][ y0 ] != PRED_L1 ) { | |
| if( num_ref_idx_l0_active_minus1 > 0 ) | |
| ref idx_l0[ x0 ][ y0 ] | |
| mvd_coding( x0, y0, 0 ) | |
| if( use_affine_flag){ | 1-5 |
| mvd_coding( x0, y0, 0 ) /* second control point when affine mode is used */ | 1-6 |
| mvd_coding( x0, y0, 0 ) /* third control point when affine mode is used */ | 1-7 |
| } | |
| mvp_l0_flag[ x0 ][ y0 ] | |
| } | |
| if( inter_pred_idc[ x0 ][ y0 ] != PRED_L0 ) { | |
| if( num_ref_idx_l1_active_minus1 > 0 ) | |
| ref_idx_l1[ x0 ][ y0 ] | |
| if( mvd_l1_zero_flag &&inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| if( use_affine_flag){ | 1-8 |
| mvd_coding( x0, y0, 1 ) /* second control point when affine mode is used | 1-9 |
| */ | |
| mvd_coding( x0, y0, 1 ) /* third control point when affine mode is used */ | 1-10 |
| } | |
| mvp_l1_flag[ x0 ][ y0 ] | |
| } | |
| } | |
| } | |
| } | |

In contribution C1016 submitted to ITU-VCEG (Lin, et al., “Affine transform prediction for next generation video coding”, ITU-U, Study Group 16, Question Q6/16, Contribution C1016, September 2015, Geneva, CH), a four-parameter affine prediction is disclosed, which includes the affine Merge mode and affine Inter mode. When an affine motion block is moving, the motion vector field of the block can be described by two control point motion vectors or four parameters as follows, where (vx, vy) represents the motion vector.

$$\{ \begin{matrix}{x}^{′} = ax + by + e \\ \begin{matrix}{y}^{′} = - bx + ay + f \\ vx = x - {x}^{′}\end{matrix} {⇒}^{Δ} \{ \begin{matrix}vx = ( 1 - a ) x - by - e \\ vy = ( 1 - a ) y + bx - f\end{matrix} \\ vy = y - {y}^{′}\end{matrix} \qquad ( 4 )$$

An example of the four-parameter affine model is shown in FIG. 4A. The transformed block is a rectangular block. The motion vector field of each point in this moving block can be described by the following equation:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} \qquad ( 5 )$$

Where (v₀ₓ, v_{0y}) is the control point motion vector (i.e., v₀) at the upper-left corner of the block, and (v₁ₓ, v_{1y}) is another control point motion vector (i.e., v₁) at the upper-right corner of the block. When the MVs of two control points are decoded, the MV of each 4×4 block of the block can be determined according to the above equation. In other words, the affine motion model for the block can be specified by the two motion vectors at the two control points. Furthermore, while the upper-left corner and the upper-right corner of the block are used as the two control points, other two control points may also be used. An example of motion vectors for a current block can be determined for each 4×4 sub-block based on the MVs of the two control points as shown in FIG. 4B according to eq. (5).

In contribution C1016, for an Inter mode coded CU, an affine flag is signalled to indicate whether the affine inter mode is applied or not when the CU size is equal to or larger than 16×16. If the current CU is coded in affine Inter mode, a candidate MVP pair list is built using the neighbour valid reconstructed blocks. As shown in FIG. 5, the v₀ corresponds to motion vector V0 of the block at the upper-left corner of the current block, which is selected from the motion vectors of the neighbouring block a0 (referred as the upper-left corner block), a1 (referred as the left-top block)and a2 (referred as a top-left block), and the v₁ corresponds to motion vector V1 of the block at the upper-right corner of the current block, which is selected from the motion vectors of the neighbouring block b0 (referred as the right-top block) and b 1 (referred as the upper-right corner block). In order to select the candidate MVP pair, a “DV” (named as distortion value in this disclosure) is calculated according to:

deltaHor=MVB−MVA

deltaVer=MVC−MVA

DV=|deltaHor_x*height−deltaVer_y*widths|+|deltaHor_y*height−deltaVer_x*width| (6)

In the above equation, MVA is the motion vector associated with the block a0, a1 or a2, MVB is selected from the motion vectors of the block b0 and b 1 and MVC is selected from the motion vectors of the block c0 and c1. The MVA and MVB that have the smallest DV are selected to form the MVP pair. Accordingly, while only two MV sets (i.e., MVA and MVB) are to be searched for the smallest DV, the third DV set (i.e., MVC) is also involved in the selection process. The third DV set corresponds to motion vector of the block at the lower-left corner of the current block, which is selected from the motion vectors of the neighbouring block c0 (referred as the bottom-left-top block) and c1 (referred as the lower-left corner block).

For a block coded in the AMVP mode, the index of candidate MVP pair is signalled in the bit stream. The MV difference (MVD) of the two control points are coded in the bitstream.

In contribution C1016, an affine Merge mode is also proposed. If the current block is a Merge coded PU, the neighbouring five blocks (A0, A1, B0, B1 and B2 blocks in FIG. 6) are checked whether any of them is affine Inter mode or affine Merge mode. If yes, an affine flag is signalled to indicate whether the current PU is affine mode. When the current PU is applied in affine merge mode, it gets the first block coded with affine mode from the valid neighbour reconstructed blocks. The selection order for the candidate block is from bottom-left, right-top, upper-right corner, lower-left corner to upper-left corner (A1->B1 ->B0->A0->B2) as shown in FIG. 6. The affine parameters of the affine coded blocks are used to derive the v₀ and v₁for the current PU.

Perspective Model

The perspective motion model can be used to describe camera motions such as zoom, pan and tilt. This model can be described as follows:

x′=(a0 +a1*x+a2*y)/(1+c1*x+c2*y), and

y′=(b0+b1*x+b2*y)/(1+c1*x+c2*y) (7)

In this model, eight parameters are used. For each pixels A(x, y) in the area of interest, the motion vector for this case can be determined from the corresponding A′(x′, y′) and A(x, y), i.e., (x′-x, y′-y). Therefore, the motion vector for each pixel is location dependent.

In genera1, an N-parameter model can be solved by having M pixel pairs A and A′ as input. In practice, M pixel pairs can be used, where M >N. For example, in the affine model, parameter set a=(a0, a1, a2) and b=(b0, b1, b2) can be solved independently.

Let C=(1, 1, . . . , 1), X=(x₀, x₁, . . . , x_{M-1}), Y=(y₀, y₁, . . . , y_{M-1}), U==(x′₀, x′₁, . . . , x′_{M-1}) and V=(y′₀, y′₁, . . . , y′_{M 1}), then the following equations can be derived:

Ka^{T}=U, and

Kb^{T}=V. (8)

Therefore, parameter set a can be solved according to a=(K^{T}K)⁻¹(K^{T}U) and set b can be solved according to b=(K^{T}K)⁻¹(K^{T}V), where K=(C^{T}, X^{T}, Y^{T}), K^{T}K is always a 3×3 matrix regardless of the size of M.

Template Matching

Recently, motion vector derivation for the current block according to the best matching block in a reference picture has been disclosed in VCEG-AZ07 (Chen, et al., Further improvements to HMKTA-1.0, ITU-Telecommunications Standardization Sector, Study Group 16 Question 6, Video Coding Experts Group (VCEG), 52^{nd} Meeting: 19-26 Jun. 2015, Warsaw, Poland). According to this method, a selected set of reconstructed pixels (i.e., the template) around the current block is used for searching and matching pixels with the same shape of the template around a target location in the reference picture. The cost between the template of the current block and the template of the target location is calculated. The target location with the lowest cost is selected as the reference block for the current block. Since the decoder can perform the same cost derivation to determine the best location using previously coded data, there is no need to signal the selected motion vector. Therefore, the signalling cost of motion vector is not needed. Accordingly, the template matching method is also called decoder-side derived motion vector derivation method. Also, motion vector predictors can be used as the start points for such template matching procedure to reduce required search.

In FIG. 7, an example of template matching is shown, where one row of pixels (714) above current block and one column of pixels (716) to the left of the current block (712) in the current picture (710) are selected as the template. The search starts from the collocated position in the reference picture. During the search, the same “L” shape reference pixels (724 and 726) in different locations are compared one by one with the corresponding pixels in the template around the current block. The location with minimum overall pixel matching distortion is determined after search. At this location, the block that has the optimal “L” shape pixels as its top and left neighbours (i.e., the smallest distortion) is selected as the reference block for the current block. The motion vector 730 is determined without the need of signalling.

Optical Flow

Motion vector fields of current picture can be calculated and derived via optical flow method through analysis of adjacent pictures.

In order to improve coding efficiency, another decoder-side motion vector derivation method has also been disclosed in VCEG-AZ07. According to VCEG-AZ07, the decoder-side motion vector derivation method uses a Frame Rate Up-Conversion (FRUC) Modes referred as bilateral matching for blocks in B-slice. On the other hand, the template matching is used for locks in P-slice or B-slice.

In this invention, methods utilizing motion compensation to improve coding performance of existing coding systems are disclosed.

### SUMMARY

Methods and apparatus of Inter prediction for video coding performed by a video encoder or a video decoder that utilizes motion vector prediction(MVP) to code a motion vector (MV) associated with a block coded with coding modes including affine Inter mode are disclosed. MVP pairs for the current block are derived based on a first set of neighbouring blocks and a second set of neighbouring blocks for a first control point and a second control point respectively for representing an affine motion model associated with the current block. Each MVP pair consist of a first MV determined from the first set of neighbouring blocks and a second MV determined from the second set of neighbouring blocks. A distortion value for each MVP pair is evaluated using only the first MV and the second MV in each MVP pair to select a final MVP pair according to the distortion value. A MVP candidate list including the final MVP pair as a MVP candidate is generated. If the affine Inter mode is used for the current block and the final MVP pair is selected, the current MV pair associated with the affine motion model is encoded at the video encoder side or decoded at the video decoder side using the final MVP pair as a predictor.

In the above method, the distortion value (DV) can be calculated based on the first MV MVP₀, MVP₀=(MVP₀_{_}ₓ, MVP₀_{_}_{y})) and the second MV (MVP₁, MVP₁=(MVP₁_{_}ₓ, MVP₁_{_}_{y})) in each MVP pair according to DV=|MVP₁_{_}ₓ−MVP₀_{_}ₓ|+|MVP₁_{_}_{y}−MVP₀_{_}_{y}|. The distortion value (DV) may also calculated by introducing an intermediate MV (MVP₂, MVP₂=(MVP₂_{_}ₓ, MVP₂_{_}_{y})) with MVP₂_{_}ₓ=−(MVP₁_{_}_{y}−MVP₀_{_}_{y}) * PU_height/PU_width+MVP₀_{_}ₓ and MVP₂_{_}_{y}=−(MVP₁_{_}ₓ−MVP₀_{_}ₓ) * PU_height/PU_width+MVP₀_{_}_{y}, and the DV calculation becomes DV =|(MVP₁_{_}ₓ−MVP₀_{_}ₓ)* PU_height−(MVP₂_{_}_{y}−MVP₀_{_}_{y})* PU_width|+|(MVP₁_{_}_{y}−MVP₀_{_}_{y})* PU_height−(MVP₂_{_}ₓ−MVP₀_{_}ₓ)* PU_width|, wherein PU_height corresponds to height of the current block and PU width corresponds to width of the current block. In one embodiment, the MVP pair with smaller distortion value is selected as the final MVP pair.

A second method is disclosed, where MVP sets for the current block are determined based on a first set of neighbouring blocks, a second set of neighbouring blocks and a third set of neighbouring blocks for a first control point, a second control point and a third control point respectively for representing a 6-parameter affine motion model associated with the current block. Each MVP set consists of a first MV determined from the first set of neighbouring blocks, a second MV determined from the second set of neighbouring blocks and a third MV determined from the third set of neighbouring blocks. A distortion value for each MVP set is evaluated using the first MV, the second MV and the third MV in each MVP set to select a final MVP set according to the distortion value. A MVP candidate list including the final MVP set as a MVP candidate is generated. If affine Inter mode is used for the current block and the final MVP set is selected, the current MV set associated with the 6-parameter affine motion model is encoded at the video encoder side by signalling the MV differences between the current MV set and the final MVP set or is decoded at the video decoder side using the final MVP set and the MV differences between the current MV set and the final MVP set.

In the second method, the first set of neighbouring blocks consists of a upper-left corner block, a left-top block and a top-left block, the second set of neighbouring blocks consists of a right-top block and a upper-right corner block, and the third set of neighbouring blocks consists of a bottom-left block and a lower-left corner block. Various ways to calculate the distortion value are disclosed.

A third method is disclosed, where one or more decoder-side derived MVs are derived for at least one of control points associated with an affine motion model for the current block using template matching or bilateral matching or using a function of motion vectors associated with neighbouring blocks. The function of motion vectors associated with neighbouring blocks excludes selecting one derived MV from spatial, temporal or both spatial and temporal neighbouring blocks solely based on availability, priority order or both of corresponding MVs of the spatial, temporal or both spatial and temporal neighbouring blocks. A MVP candidate list including an affine MVP candidate is generated, where the affine MVP candidate includes one or more decoder-side derived MVs. If the affine Inter mode is used for the current block and the affine MVP candidate is selected, the current MV set associated with the affine motion model is encoded at the video encoder side by signalling at least one MV difference between the current MV set and the affine MVP candidate, or is decoded at the video decoder side using the affine MVP candidate and at least one MV difference between the current MV set and the affine MVP candidate.

In the third method, the decoder-side derived MVs correspond to the MVs associated with three control points or two control points for the current block. In this case, the MV associated with each control point corresponds to the MV at a respective corner pixel or the MV associated with smallest block containing the respective corner pixel. A decoder-side derived MV flag can be signalled to indicate whether the decoder-side derived MVs are used for the current block. The two control points are located at upper-left and upper-right corners of the current block and the three control points include an additional location at lower-left corner. The function of motion vectors associated with neighbouring blocks may correspond to an average or a median of motion vectors associated with neighbouring blocks corresponds.

When the template matching is used to derive said one or more decoder-side derived MVs associated with the control points associated with an affine motion model for the current block, the control points are within respective n×n corner sub-blocks and each decoder-side derived MV is derived using a template corresponding to respective n×n neighbouring blocks of each n×n corner sub-block according to one embodiment, where n is a positive integer. The respective n×n corner sub-blocks may correspond to an upper-left block and an upper-right block of the current block for a 4-parameter affine model and the respective n×n corner sub-blocks may correspond to the upper-left block, the upper-right block and a lower-left block of the current block for a 6-parameter affine model. When the template matching is used, the control points may also correspond to corner pixels of the current block and each decoder-side derived MV is derived using a template corresponding to respective neighbouring pixels within a row, a column or both of each corner pixel of the current block. The corner pixels may correspond to an upper-left corner pixel and an upper-right corner pixel of the current block for a 4-parameter affine model and the corner pixels may correspond to the upper-left corner pixel, the upper-right corner pixel and a lower-left corner pixel of the current block for a 6-parameter affine model.

### BRIEF DESCRIPTION OF DRAWINGS

FIG. 1 illustrates an example of translational motion model.

FIG. 2 illustrates an example of scaling motion model.

FIG. 3 illustrates an example of affine motion model.

FIG. 4A illustrates an example of the four-parameter affine model, where the transformed block is still a rectangular block.

FIG. 4B illustrates an example of motion vectors for a current block determined for each 4×4 sub-block based on the MVs of the two control points.

FIG. 5 illustrates an example of deriving motion vectors for three corner blocks based on respective neighbouring blocks.

FIG. 6 illustrates an example of deriving affine Merge candidate list based on the neighbouring five blocks (A0, A1, B0, B1 and B2).

FIG. 7 illustrates an example of template matching, where one row of pixels above current block and one column of pixels to the left of the current block in the current picture are selected as the template.

FIG. 8 illustrates an example of deriving a new affine Merge candidate based on affine coded blocks in the reference picture and within a window.

FIG. 9 illustrates an example of three control points of the current block, where the three control points correspond to the upper-left, upper-right and lower-left corners.

FIG. 10 illustrates an example of neighbouring pixels for template matching at control points of the current block, where the templates of neighbouring pixels (areas filled with dots) for the three control points are indicated.

FIG. 11 illustrates an example of for the Merge candidate construction process according to the disclosed methods, where the MVs of five neighbouring blocks (A to E) of the current block are used for the Merge candidate list construction.

FIG. 12 illustrates an example of three sub-blocks (i.e., A, B and C) used to derive the MVs for 6-parameter affine model at the decoder side.

FIG. 13 illustrates an exemplary flowchart for a video coding system with an affine Inter mode incorporating an embodiment of the present invention, where the system uses only two motion vectors at two control points to select a MVP pair.

FIG. 14 illustrates an exemplary flowchart for a video coding system with an affine Inter mode incorporating an embodiment of the present invention, where the system uses three motion vectors at three control points to derive a MVP set for blocks coded using 6-parameter affine model.

FIG. 15 illustrates an exemplary flowchart for a video coding system with an affine Inter mode incorporating an embodiment of the present invention, where the system generates an AMVP (advanced motion vector predictor) candidate list including a MVP set that includes one or more decoder-side derived MVs.

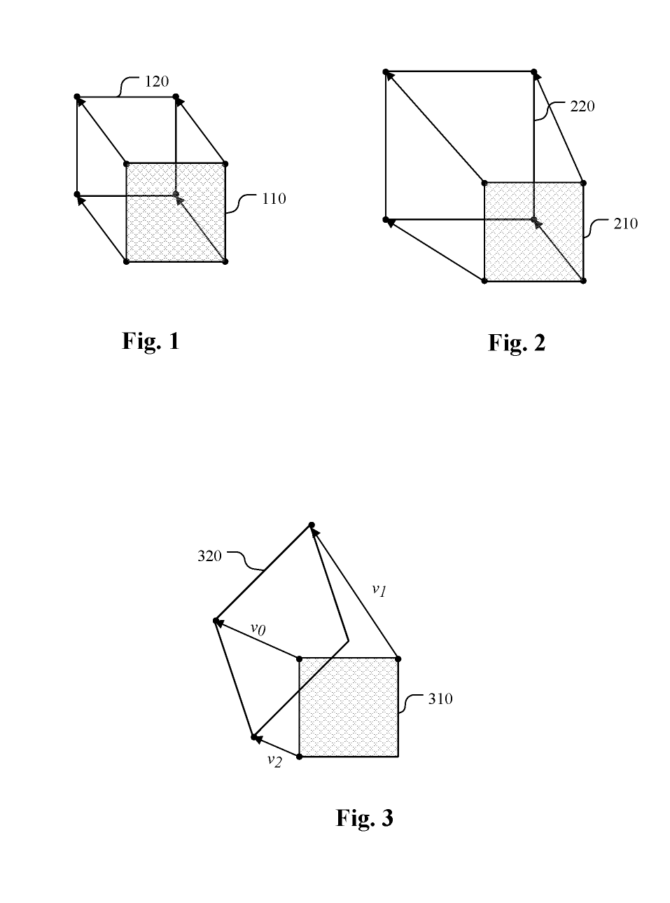

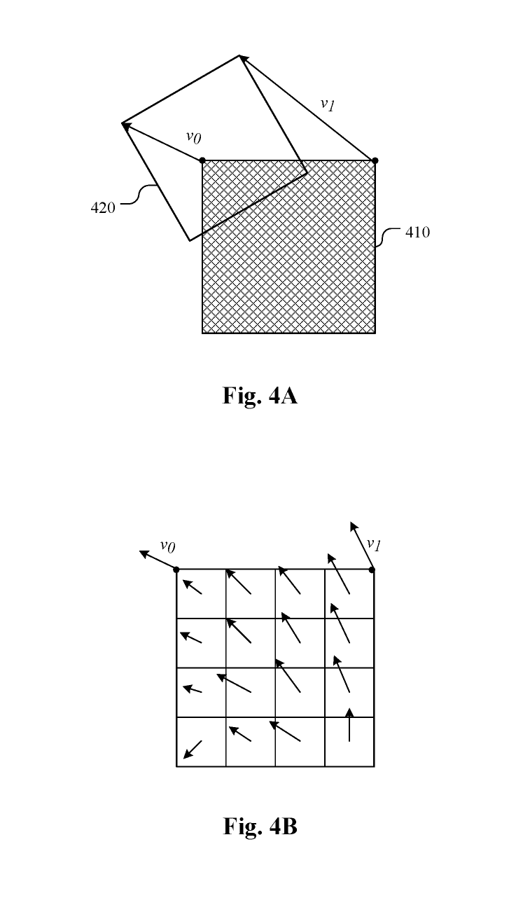

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

In the present invention, various methods of utilizing affine motion estimation and compensation for video compression are disclosed. In particular, the affine motion estimation or compensation is used for coding video data in a Merge mode or an Inter prediction mode.

The affine motion compensation has been proposed to the standardization body of future video coding technology under ITU ISO/IEC JTC1/SC29/WG11. A Joint Exploration Test Model 1 (JEM1) software has been established in October 2015 as a platform for collaborators to contribute proposed elements. The future standardization action could either take the form of additional extension(s) of HEVC or an entirely new standard.

In the case of extension(s) of HEVC, when affine motion compensation is used for a current block coded in Merge mode, some of its derived Merge candidates may be affine coded blocks. For example, among five spatial Merge candidates for the current block 610 in FIGS. 6, A1 and B1 may be coded using affine motion compensation while A0, B0 and B2 are coded in the traditional Inter mode. According to HEVC, the order of Merge candidates in the list is A1->B1 ->B0 ->A0->B2 ->temporal candidates->other candidates. A Merge index is used to indicate which candidate in the Merge list is actually used. Furthermore, for affine motion compensation based on the existing HEVC extensions, the affine motion compensation is only applied to 2N×2N block size (i.e., PU). For the Merge mode, if merge flag is true (i.e., Merge mode used) and when there is at least one spatial neighbouring block coded using the affine Inter mode, a flag is used to signal whether the current block is coded in affine Merge mode. If the current block is coded in the affine Merge mode, the motion information of the first affine coded neighbour is used as the motion the current block. There is no need to signal the motion information for the current block. For the Inter prediction mode (i.e., advance motion vector prediction (AMVP) mode), the 4-parameter affine model is used. The motion vector differences (MVDs) for the upper-left and the upper-right corners are signalled. For each 4×4 sub-block in the CU, its MV is derived according to the affine model. Also, according to the existing HEVC extensions, affine Merge candidate list is separated from Inter Merge candidate list. Therefore, the system has to generate and maintain two Merge lists.

Improved Affine Merge Mode

In order to improve the coding performance or reduce the processing complexity associated with affine Merge mode, various improvements are disclosed for the affine Merge mode in this disclosure.

Method A—Unified Merge List

According to method A, a unified Merge candidate list is generated and used for both affine Inter coded neighbouring blocks and traditional Inter coded neighbouring blocks. The traditional Inter coded block is also referred as a regular Inter codedblock.

According to method A, there is no need for two separate candidate lists for these two coding modes. In one embodiment, the candidate selection order is the same as that in HEVC, i.e., A1->B1 ->B0->A0->B2->temporal candidates->other candidates as shown in FIG. 6. The affine Merge candidates can be used to replace the conventional Inter candidate or inserted into the Merge list. For example, if blocks B1 and B2 are affine coded, the above order becomes A1->B1_{A}->B0->A0->B2_{A}->temporal candidates->other candidates according to this embodiment, where B1_{A} and B2_{A} indicate affine coded block B1 and B2. Nevertheless, other candidate selections or orders can apply.

A coding system using the unified affine Merge and Inter Merge candidate list according to the present invention is compared to the conventional coding system using separate affine Merge list and Inter Merge list. The system with the unified Merge candidate list has shown better coding efficiency by more than 1% for Random Access test condition and 1.78% for the Low-Delay B-Frame test condition.

Method B—Merge Index to Indicate the Use of Affine Merge Mode

According to method B, a Merge index to indicate the use of affine Merge mode is signalled. This will eliminate the need for specific affine flag signalling or conditions in the Merge mode. If the Merge index points to a candidate that is affine coded, the current block will inherit the affine model of the candidate block and derive motion information based on that the affine model for the pixels in current block.

Method C—Affine Merge Mode for PU Other than 2N×2N

As mentioned above, the affine Merge mode based on the existing HEVC extensions is applied to CU with 2N×2N partition only. According to method C, a PU-level affine Merge mode is disclosed, where the affine Merge mode is extended to different PU partitions, such as 2N×N, N×2N, N×N, AMP (asymmetric motion partition) mode, etc. in additional to the 2N×2N partition. For each PU in a CU, the affine Merge mode follows the same spirit as methods A and B. In other words, a unified Merge candidate list construction can be used and a Merge index indicating an affine coded neighbour candidate may be signalled. Some constraints on the allowed PU partitions may be imposed. For example, in addition to 2N×2N, only PUs of 2N×N and N×2N partitions, are enabled for affine Merge mode. In another embodiment, in addition to 2N×2N, only PUs of 2N×N, N×2N and N×N partitions are enabled for affine Merge mode. In yet another embodiment, in addition to 2N×2N, 2N×N, N×2N and N×N, only AMP mode with CU size larger than 16×16 is enabled for affine Merge mode.

In another embodiment, the affine-model generated Merge candidate can be inserted after the normal Merge candidate for the unified Merge candidate list generation. For example, according to the order of Merge candidate selection, if the neighbouring block is an affine coded PU, the normal Merge candidate (i.e., the convention Merge candidate, also named regular Merge candidate in this disclosure) of the block is inserted first, and the affine Merge candidate of the block is then inserted after the normal Merge candidate. For example, if blocks B1 and B2 are affine coded, the order becomes A1->B1->B1_{A}->B0->A0->B2->B2_{A}->temporal candidates->other candidates.

In another embodiment, all affine-model generated Merge candidates can be inserted in front of the unified Merge candidate list for the unified Merge candidate list generation. For example, according to the order of Merge candidate selection, all available affine Merge candidates are inserted in the front of the list. The HEVC Merge candidate construction method can then be used to generate the normal Merge candidates. For example, if blocks B1 and B2 are affine coded, the order becomes B1_{A}->B2_{A}->A1->B1->B0->A0->B2->temporal candidates->other candidates. In another example, only partial affine coded blocks are inserted in front of the Merge candidate list. Furthermore, part of the affine coded blocks can be used to replace the regular Inter candidate and the remaining affine coded blocks can be inserted into the unified Merge candidate list.

One exemplary syntax table for methods A, B and C is shown in Table 2. As shown in Table 2, signalling of use_affine _flag is not needed when Merge mode is used as indicated by Note (2-2), where text enclosed in a box indicates deletion. Also, there is no need to perform the test regarding “whether at least one merge candidate is affine coded &&PartMode==PART_2N×2N” as indicated by Notes (2-1) and (2-3). In fact, there is no change as compared to the original HEVC standard (i.e., the version without affine motion compensation).

TABLE 2

| | |
|---|---|
| prediction_unit( x0, y0, nPbW, nPbH ) { | Note |
| if( cu_skip_flag[ x0 ][ y0 ] ) } | |
| if( MaxNumMergeCand > 1 ) | |
| merge_idx[ x0 ][ y0 ] | |
| } else { /* MODE_INTER */ | |
| merge_flag[ x0 ][ y0 ] | |
| if( merge_flag[ x0 ][ y0 ] ) { | |
| 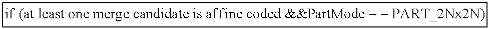 | 2-1 |
| 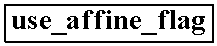 | 2-2 |
| 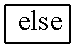 | 2-3 |
| if( MaxNumMergeCand > 1 ) | |
| merge_idx[ x0 ][ y0 ] | |
| } else { | |
| . . . . . . | |

Method D—New Affine Merge Candidates

According to method D, new affine Merge candidates are added to the unified Merge candidate list. Since previously affine coded blocks may not belong to the neighbouring blocks of the current block. If none of the neighbouring blocks of the current block is affine coded, there will be no affine Merge candidate available. However, according to method D, affine parameters of previously coded affine blocks can be stored and used to generate new affine Merge candidates. When the Merge index points to one of these candidates, the current block is coded in affine mode and the parameters of the selected candidate are used to derive motion vectors for current block.

In the first embodiment of new affine Merge candidates, parameters of N previously coded affine blocks parameters are stored, where N is a positive integer number. Duplicated candidates, i.e., blocks with the same affine parameters, can be pruned.

In the second embodiment, the new affine Merge candidates are added into the list only when the new affine candidates are different from the affine Merge candidates in the current Merge candidate list.

In the third embodiment, the new affine Merge candidates from previously affine coded blocks in the reference pictures are used. Such affine Merge candidate is also called temporal affine Merge candidate. A search window can be defined with the collocated block in the reference picture as the centre. Affine coded blocks in the reference picture and within this window are considered as the new affine Merge candidates. An example of this embodiment is shown in FIG. 8, where picture 810 corresponds to the current picture and picture 820 corresponds to the reference picture. Block 812 corresponds to the current block in the current picture 810 and the block 822 corresponds to the collocated block corresponding to the current block in the reference picture 820. The dash-lined block 824 indicates the search window in the reference picture. Blocks 826 and 828 represent two affine coded blocks in the search window. Accordingly, these two blocks can be inserted into the Merge candidate list according to this embodiment.

In the fourth embodiment, these new affine Merge candidates are placed in the last position of the unified Merge candidate list, i.e., the end of the unified Merge candidate list.

In the fifth embodiment, these new affine Merge candidates are placed after the spatial and temporal candidates in the unified Merge candidate list.

In the sixth embodiment, the combinations of previous embodiments are formed, if applicable. For example, the new affine Merge candidates from the search window in the reference picture can be used. At the same time, these candidates have to be different from existing affine Merge candidates in the unified Merge candidate list, such as those from spatial neighbouring blocks.

In the seventh embodiment, one or more global affine parameters are signalled in the sequence, picture, or slice-level header. As is known in the art, the global affine parameter can describe the affine motion for an area of a picture or the whole picture. A picture may have multiple areas that can be modelled by the global affine parameter. The global affine parameter can be used to generate one or more affine Merge candidates for the current block according to this embodiment. The global affine parameter can be predicted from the reference pictures. In this way, the differences the current global affine parameters and previous global affine parameters are signalled. The generated affine Merge candidates are inserted into the unified Merge candidate list. Duplicated ones (blocks with the same affine parameters) can be pruned.

Improved Affine Amvp Mode

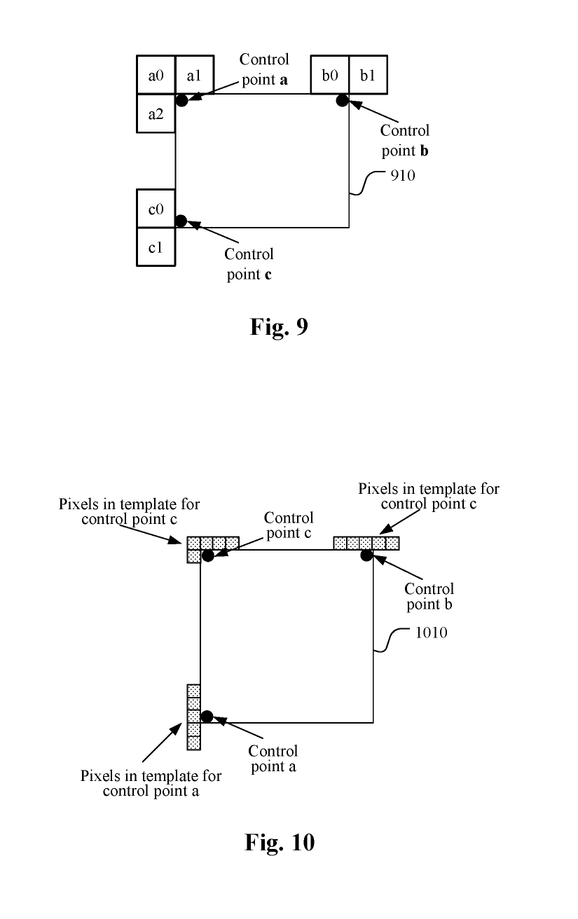

In order to improve the coding performance or reducing processing complexity associated with affine AMVP mode, various improvements are disclosed for the affine AMVP mode. When affine motion compensation is used, generally three control points are needed for motion vector derivation. FIG. 9 illustrates an example of three control points of the current block 910 are shown, where the three control points correspond to the top-left, top-right and bottom-left corners. In some implementations, two control points are used with certain simplification. For example, with the assumption that the affine transformation does not have deformation, two control points are adequate. In genera1, there can be N (N=0, 1, 2, 3, 4) control points, where motion vectors need to be signalled for these control points. According to one method of the present invention, some derived or estimated motion vectors can be used to represent the signalled motion vectors in some of the control points. For example, in the case that the total number of signalled MVs is M (M<=N), when M<N, it means at least one control point is not signalled via a corresponding MVD. Therefore, the motion vector(s) in this control point is derived or predicted. For example, in the case of three control points, the motion vectors in two control points may be signalled while the motion vector in the third control point is acquired by motion vector derivation or prediction. In another example, in the case of two control points, the motion vector of one control point is signalled while the motion vector of the other control point is acquired by motion vector derivation or prediction.

In one method, the derived or predicted motion vector for control point X (X corresponding to any control point for the block) is a function of the motion vectors of the spatial and temporal neighbouring blocks near this control points. In one embodiment, the average of available neighbouring motion vectors is used as the motion vector of the control point. For example, the derived motion vector for control point b is the average of the motion vectors in b₀ and b₁ as shown in FIG. 9. In another embodiment, the median value of available neighbouring motion vectors is used as the motion vector of the control point. For example, the derived motion vector for control point a is the median of the motion vectors in a₀, aₗ and a₂ as shown in FIG. 9. In yet another embodiment, the motion vector from one of the neighbouring blocks is selected. In this case, a flag can be sent to indicate that the motion vector of one block (e.g. a1 if available) is selected to represent the motion vector at control point a as shown in FIG. 9. In yet another embodiment, the control point X that does not have a MVD signalled is determined on a block by block basis. In other words, for each particular coding block, a control point is selected to use a derived motion vector without signalling its MVD. The selection of such a control point for a coding block can be done either by explicit signalling or implicitly inferring. For example, in the explicit signalling case, a 1-bit flag can be used for each control point before sending its MVD to signal if the MVD is 0. If the MVD is 0, the MVD for this control point is not signalled.

In another method, the derived or predicted motion vector from other motion vector derivation processes is used, where other motion vector derivation processes do not derive the motion vector directly from spatial or temporal neighbouring blocks. The motion vector in the control point can be the motion vector for the pixel at the control point or the motion vector for the smallest block (e.g. 4×4 block) that contains the control point. In one embodiment, an optical flow method is used to derive the motion vector at the control point. In another embodiment, a template matching method is used to derive the motion vector in the control point. In yet another embodiment, a list of motion vector predictors for the MV in the control point is constructed. A template matching method can be used to determine which of the predictors has the minimum distortion (cost). The selected MV is then used as the MV for the control point.

In yet another embodiment, affine AMVP mode can be applied to PU of different sizes beside 2N×2N.

One exemplary syntax table for the above methods is shown in Table 3 by modifying existing HEVC syntax table. The example assumes that a total of three control points are used and among them, one control point uses derived motion vector. Since the present method applies affine AMVP to PUs beside 2N×2N partition, the restricting condition “&&PartMode==PART_2N×2N” for signalling use_affine_flag is deleted as indicated by Note (3-1). Since there are three control points (i.e., three MVs) to signal for each selected list, two additional MVs via MVDs need to be signalled in addition to the one for original HEVC (i.e., the version without affine motion compensation). According to the present method, one control point uses derived motion vector. Therefore, only one additional MV needs to be signalled by way of MVD. Therefore the second addition MVD signalling for List_0 and List_1 are eliminated as indicated by Note (3-2) and (3-3) respectively for the bi-prediction case. In Table 3, the text enclosed by a box indicates deletion.

TABLE 3

| | |
|---|---|
| . . . . . . | Note |
| if( MaxNumMergeCand >1 ) | |
| merge_idx[ x0 ][ y0 ] | |
| } else { | |
| if( slice_type = = B ) | |
| inter_pred_idc[ x0 ][ y0 ] | |
| 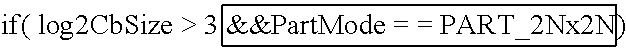 | 3-1 |
| use_affine_flag | |
| if( inter_pred_idc[ x0 ][ y0 ] != PRED_L1 ) { | |
| if( num_ref_idx_l0_active_minus1 > 0 ) | |
| ref_idx_l0[ x0 ][ y0 ] | |
| mvd_coding( x0, y0, 0 ) | |
| if( use_affine_flag){ | |
| mvd_coding( x0, y0, 0 ) /* second control point when affine mode is used | |
| */ | |
| 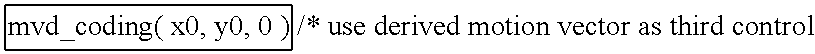 | 3-2 |
| point | |
| when affine mode is used, no need to signal */ | |
| } | |
| mvp_l0_flag[ x0 ][ y0 ] | |
| } | |
| if( inter_pred_idc[ x0 ][ y0 ] != PRED_L0 ) { | |
| if( num_ref_idx_l1_active_minus1 > 0 ) | |
| ref idx_l1[ x0 ][ y0 ] | |
| if( mvd_l1_zero_flag &&inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| if( use_affine_flag){ | |
| mvd_coding( x0, y0, 1) /* second control point when affine mode is | |
| used */ | |
| 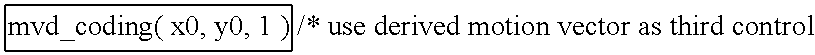 | 3-3 |
| point | |
| when affine mode is used, no need to signal */ | |
| } | |
| mvp_l1_flag[ x0 ][ y0 ] | |
| } | |
| } | |
| } | |
| } | |

One exemplary decoding process corresponding to the above method is described as follows for the case with three control points:
1.After the affine flag for AMVP is decoded and if the affine flag is true, the decoder starts parsing two MVDs.
2.The first decoded MVD is added to the MV predictor for the first control point (e.g. control point a in FIG. 9).
3.The second decoded MVD is added to the MV predictor for the second control point (e.g. control point b in FIG. 9).
4.For the third control point, the following steps apply:

Derive a set of MV predictors for the motion vector at the control point (e.g. control point c in FIG. 9). The predictors can be, MVs from block a1 or a0 in FIG. 9, or collocated block temporally.

Use template matching method to compare all the predictors and select one with the minimum cost.

Use the selected MV as the MV for the third control point.

Another exemplary decoding process corresponding to the above method is described as follows for the case with three control points:
1.After the affine flag for AMVP is decoded and the affine flag is true, the decoder starts parsing two MVDs.
2.The first decoded MVD is added to the MV predictor for the first control point (e.g. control point a in FIG. 9.
3.The second decoded MVD is added to the MV predictor for the second control point (e.g. control point b in FIG. 9).
4.For the third control point (e.g. control point c in FIG. 9), the following steps apply:

Set a search start point and the search window size. For example, the search start point can be indicated by the motion vector from neighbour block a1 or the MV predictor with the minimum cost from the example above). The search window size can be ±1 integer pixel in both the x and y directions.

Use the template matching method to compare all the locations in the search window and select one location with the minimum cost.

Use the displacement between the selected location and the current block as the MV for the third control point.
5.With the MVs at all three control points available, perform affine motion compensation for the current block.

In another embodiment, different reference lists can use different Inter modes. For example, the List_0 can use normal Inter mode while the List_1 can use affine Inter mode. The affine flag is signalled for each reference list in this case as shown in Table 4. The syntax structure in Table 4 is similar to that in Table 3. The deletion of the restricting condition “&&PartMode==PART_2N×2N” for signalling use_affine_flag is indicated in Note (4-1). The deletion of signalling the third MV (i.e., the second additional MV) is indicated in Note (4-2). However, an individual use_affine_flag is signalled as indicated in Note (4-4) for List_1. Also, the restricting condition “&&PartMode==PART_2N×2N” for signalling use_affine_flag is deleted as indicated in Note (4-3) for List_1. The deletion of signalling the third MV (i.e., the second additional MV) for List _1 is indicated in Note (4-5).

TABLE 4

| | |
|---|---|
| . . . . . . | Note |
| if( MaxNumMergeCand > 1 ) | |
| merge_idx[ x0 ][ y0 ] | |
| } else { | |
| if( slice_type = = B ) | |
| inter_pred_idc[ x0 ][ y0 ] | |
| if( inter_pred_idc[ x0 ][ y0 ] != PRED_L1 ) { | |
| 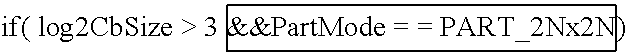 | 4-1 |
| use_affine_flag_l0 | |
| if( num_ref_idx_l0_active_minusl > 0 ) | |
| ref_idx_l0[ x0 ][ y0 ] | |
| mvd_coding( x0, y0, 0 ) | |
| if( use_affine_flag_l0){ | |
| mvd_coding( x0, y0, 0) /* second control point when affine mode is used | |
| */ | |
| 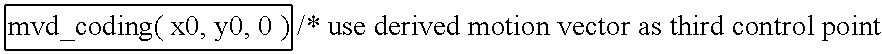 | 4-2 |
| when affine mode is used, no need to signal */ | |
| } | |
| mvp_l0_flag[ x0 ][ y0 ] | |
| } | |
| if( inter_pred_idc[ x0 ][ y0 ] != PRED_L0 ) { | |
| 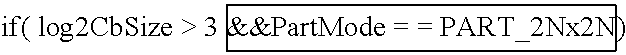 | 4-3 |
| use_affine_flag_l1 | 4-4 |
| if( num_ref_idx_l1_active_minus1 > 0 ) | |
| ref_idx_l1[ x0 ][ y0 ] | |
| if( mvd_l1_zero_flag &&inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| if( use_affine_flag_l1){ | |
| mvd_coding( x0, y0, 1 ) /* second control point when affine mode is | |
| used */ | |
| 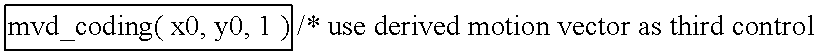 | 4-5 |
| point | |
| when affine mode is used, no need to signal */ | |
| } | |
| mvp_l1_flag[ x0 ][ y0 ] | |
| } | |
| } | |
| } | |
| } | |

In one embodiment, the motion vector predictor (MVP) of the control points can be derived from the Merge candidates. For example, the affine parameter of one of the affine candidates can be used to derive the MV of the two or three control points. If the reference picture of the affine Merge candidate is not equal to the current target picture, the MV scaling is applied. After the MV scaling, the affine parameter of the scaled MVs can be used to derive the MV for the control points. In another embodiment, if one or more neighbouring blocks are affine coded, the affine parameters of the neighbouring blocks are used to derived the MVP for the control points. Otherwise, the MVP generation mentioned above can be used.

Affine Inter Mode MVP Pair and Set Selection

In affine Inter mode, an MVP is used at each control point to predict the MV for this control point.

In the case of three control points at three corners, a set of MVPs is define as {MVP₀, MVP₁, MVP₂}, where the MVP₀ is the MVP of the top-left control point, MVP₁ is the MVP of the top-right control point, and the MVP₂ is the MVP of the bottom-left control point. There may be multiple MVP sets available to predict the MVs at the control points.

In one embodiment, the distortion value (DV) can be used to select the best MVP set. The MVP sets with smaller DV are selected as the final MVP sets. The DV of the MVP set can be defined as:

DV=|MVP₁−MVP₀|*PU_height+|MVP₂−MVP₀*PU_width, (9)

or

DV=|(MVP₁_{_}ₓ−MVP₀_{_}ₓ)*PU_height|+|(MVP₁_{_}_{y}−MVP₀_{_}_{y})*PU_height|+|(MVP₂_{_}ₓ−MVP₀_{_}ₓ)*PU_width|+|(MVP₂_{_}_{y}−MVP₀_{_}_{y})*PU_width|. (10)

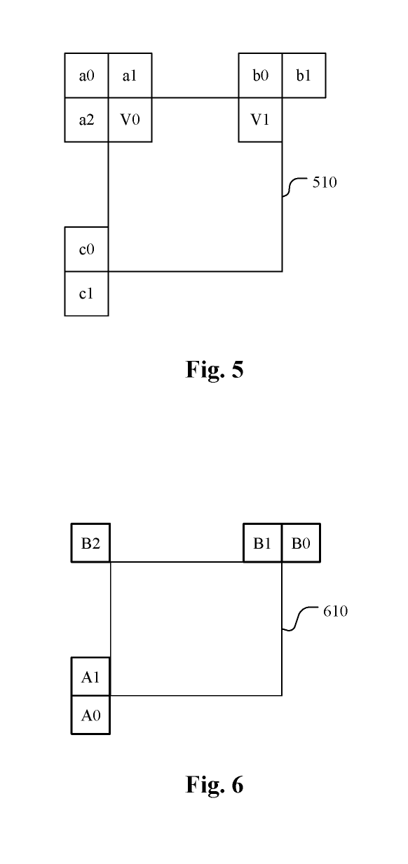

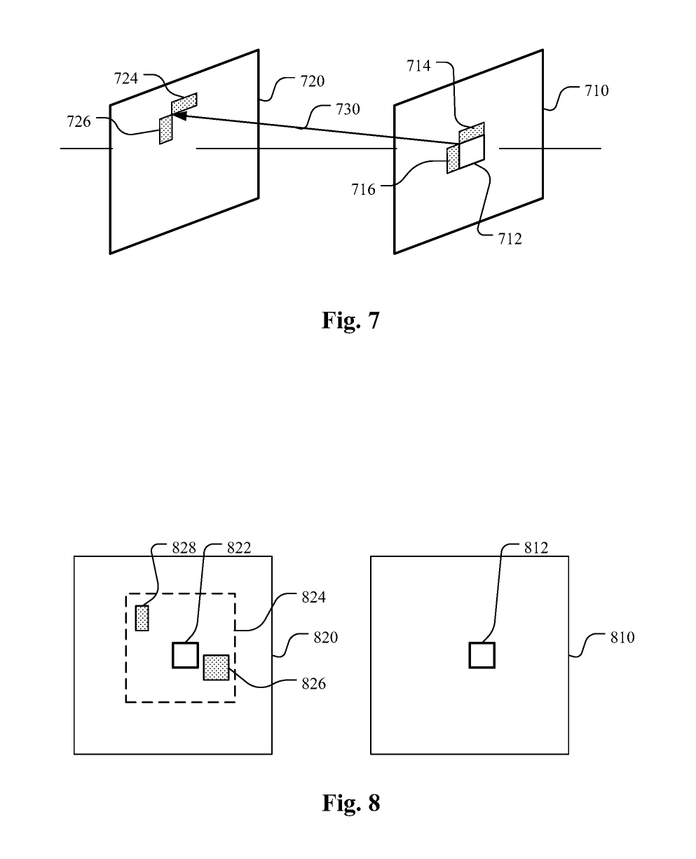

In ITU-VCEG C1016, two-control-point affine Inter mode is disclosed. In the present invention, the three-control-point (six parameters) affine Inter mode is disclosed. An example of three control point affine model is shown in FIG. 3. The MVs of the top-left, top-right, and the bottom-left points are used to form the transformed block. The transformed block is a parallelogram (320). In the affine Inter mode, the MV of the bottom-left point (v₂) needs to be signalled in the bitstream. A MVP set list is constructed according to the neighbouring blocks, such as from a0, a1, a2, b0, b1, c0, and c1 blocks in FIG. 5. According to one embodiment of the present method, one MVP set has three MVPs MVP₀, MVP₁ and MVP₂). MVP₀ can be derived from a0, a1, or a2; MVP₁ can be derived from b0 or b1; MVP₂ can be derived from c0 or c1. In one embodiment, the third MVD is signalled in the bitstream. In another embodiment, the third MVD is inferred as (0, 0).

In MVP set list construction, various MVP sets can be derived from the neighbouring blocks. According to another embodiment, the MVP sets are sorted based on the MV pair distortion. For the MVP set {MVP₀, MVP₁, MVP₂}, the MV pair distortion is defined as:

DV=|MVP₁MVP₀|+|MVP₂−MVP₀|, (11)

DV=|MVP₁MVP₀|*PU_width+|MVP₂−MVP₀*PU_height, (12)

DV=|MVP₁MVP₀|*PU_height+|MVP₂−MVP₀*PU_width, (13)

DV=|(MVP₁_{_}ₓ−MVP₀_{_}ₓ)*PU_height−(MVP₂_{_}_{y}−MVP₀_{_}_{y})*PU_width|+|(MVP_{1 y}−MVP_{0 y})*PU_height−(MVP_{2 x}−MVP_{0 x})*PU_width|, (14)

or

DV=|(MVP₁_{_}ₓ−MVP₀_{_}ₓ)*PU_width−(MVP₂_{_}_{y}−MVP₀_{_}_{y})*PU_height|+|(MVP₁_{_}_{y}−MVP₀_{_}_{y})*PU_width−(MVP₂_{_}ₓ−MVP₀_{_}ₓ)*PU_height|. (15)

In the above equations, MVPₙ_{_}ₓ is the horizontal component of MVPₙ and MVPₙ_{_}_{y} is the vertical component of MVPₙ, where n is equal to 0, 1 or 2.

In yet another embodiment, the MVP set with smaller DV has higher priority, i.e., placing in the front of the list. In another embodiment, the MVP set with larger DV has higher priority.

The gradient based affine parameter estimation or the optical flow affine parameter estimation can be applied to find the three control points for the disclosed affine Inter mode.

In another embodiment, template matching can be used to compare the overall cost among different MVP sets. The best predictor set with minimum overall cost is then selected. For example, the cost of MVP set can be defined as:

DV=template_cost (MVP₀)+template_cost (MVP₁)+template_cost (MVP₂). (16)

In the above equation, the MVP₀ is the MVP of the top-left control point, MVP₁ is the MVP of the top-right control point, and the MVP₂ is the MVP of the bottom-left control point. template_cost( ) is the cost function comparing the different between the pixels in the template of the current block and those in the template of the reference block (i.e., location indicated by MVP). FIG. 10 illustrates an example of neighbouring pixels for template matching at control points of the current block 1010. The templates of neighbouring pixels (areas filled with dots) for the three control points are indicated.

In ITU-VCEG C1016, the neighbouring MVs are used to form the MVP pair. In the present invention, a method to sort the MVP pairs (i.e., 2 control points) or sets (i.e., 3 control points) based on the MV pair or set distortion is disclosed. For a MVP pair {MVP₀, MVP₁}, the MV pair distortion is defined as

DV=|MVP₁MVP₀|, (17)

or

DV=|MVP₁_{_}ₓ−MVP₀_{_}ₓ|+|MVP₁_{_}_{y}−MVP₀_{_}_{y}| (18)

In the above equation, MVPₙ_{_}ₓ is the horizontal component of MVPₙ and MVP_{n y} is the vertical component of MVPₙ, where n is equal to 0 or 1. Furthermore, MVP₂ can be defined as:

MVP₂_{_}ₓ=−(MVP₁_{_}_{y}−MVP₀_{_}_{y})*PU_height/PU_width+MVP₀_{_}ₓ, (19)

MVP₂_{_}_{y}=−(MVP₁_{_}ₓ−MVP₀_{_}ₓ)*PU_height/PU_width+MVP₀_{_}_{y}. (20)

The DV can be determined in terms of MVP₀, MVP₁ and MVP₂:

DV=|MVP₁−MVP₀|+|MVP₂−MVP₀|. (21)

or

DV=|(MVP₁_{_}ₓ−MVP₀_{_}ₓ)*PU_height−(MVP₂_{_}_{y}−MVP₀_{_}_{y})*PU_width|+|(MVP_{1 y}−MVP_{0 y})*PU_height−(MVP_{2 x}−MVP_{0 x})*PU_width|. (22)

In the above equations, while the DV is derived based on MVP₀, MVP₁ and MVP₂. However, MVP₂ is derived based on MVP₀ and MVP₁. Therefore, the DV is actually derived from two control points. On the other hand, three control points have been used in ITU-VCEG C1016 to derive the DV. Accordingly, the present invention reducs the complexity to derive the DV compared to ITU-VCEG C1016.

In one embodiment, the MVP pair with smaller DV has higher priority, i.e., placing more toward the front of the list. In another embodiment, the MVP pair with larger DV has higher priority.

Affine Merge Mode Signalling and Merge Candidate Derivation

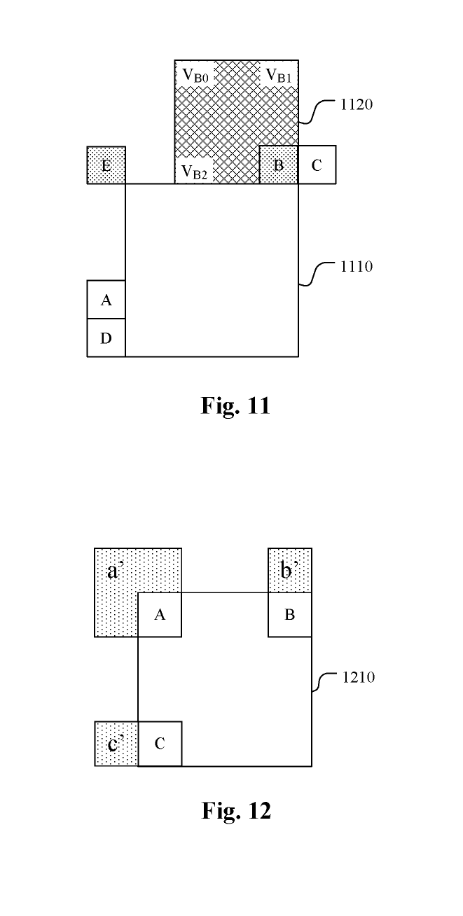

In the original HEVC (i.e., the version without affine motion compensation), all Merge candidates are the normal Merge candidates. In the present invention, various Merge candidate construction methods are disclosed. In the following, an example is illustrated for the Merge candidate construction process according to the disclosed methods, where the MVs of five neighbouring blocks (e.g. the blocks A to E in FIG. 11) of the current block 1110 are used for the unified Merge candidate list construction. The priority order A→B→C→D→E is used and blocks B and E are assumed to be coded in the affine mode. In FIG. 11, block B is within a block 1120 that is affine coded. The three-control-points MVP set for the affine Merge candidate for block B can be derived based on the three MVs (i.e., V_{B0}, V_{B1} and V_{B2}) at three control points. The affine parameter for block E can be determined similarly.

The MVP set of the three control points (V₀, V₁, and V₂ in FIG. 3) can be derived as shown below. For V₀:

V0_x=VB0_x+(VB2_x−VB0_x)*(posCurPU_Y−posRefPU_Y)/RefPU_height+(VB1_x−VB0_x)*(posCurPU_X−posRefPU_X)/RefPU_width, (23)

V0_y=VB0_y+(VB2_y−VB0_y)*(posCurPU_Y−posRefPU_Y)/RefPU_height+(VB1_y−VB0_y)*(posCurPU_X−posRefPU_X)/RefPU_width, (24)

In the above equations, V_{B0}, V_{B1}, and V_{B2} correspond to the top-left MV, top-right MV, and bottom-left MV of respect reference/neighbouring PU, (posCurPU_X, posCurPU_Y) are the pixel position of the top-left sample of the current PU relative to the top-left sample of the picture, (posRefPU_X, posRefPU_Y) is the pixel position of the top-left sample of the reference/neighbouring PU relative to the top-left sample of the picture. For V₁ and V₂, they can be derived as follows:

V₁_{_}ₓ=V_{B0}_{_}ₓ+(V_{B1}_{_}ₓ−V_{B0}_{_}ₓ)*PU_width/RefPU_width (25)

V₁_{_}_{y}=V_{B0}_{_}_{y}+(V_{B1}_{_}_{y}−V_{B0}_{_}_{y})*PU_width/RefPU_width (26)

V₂_{_}ₓ=V_{B0}_{_}ₓ+(V_{B2}_{_}ₓ−V_{B0}_{_}ₓ)*PU_height/RefPU_height (27)

V₂_{_}_{y}=V_{B0}_{_}_{y}+(V_{B2}_{_}_{y}−V_{B0}_{_}_{y})*PU_height/RefPU_height (28)

The unified Merge candidate list can be derived as shown in following examples:
1.Insert the affine candidates after respective normal candidates:
If the neighbouring block is affine coded PU, insert the normal Merge candidate of the block first, then insert the affine Merge candidate of the block. Accordingly, the unified Merge candidate list can be constructed as {A, B, B_{A}, C, D, E, E_{A}}, where X indicates the normal Merge candidate of block X and X_{A} indicates the affine Merge candidate of block X.
2.Insert all affine candidates in front of the unified Merge candidate list:
According to the candidate block position, insert all available affine Merge candidates first and then use the HEVC Merge candidate construction method to generate the normal Merge candidates. Accordingly, the unified Merge candidate list can be constructed as {B_{A}, E_{A}, A, B, C, D, E}
3.Insert all affine candidate in front of the unified Merge candidate list and remove the corresponding normal candidates:
According to the candidate block position, insert all available affine Merge candidate first and then use the HEVC Merge candidate construction method to generate the normal Merge candidates for the blocks that is not coded in affine mode. Accordingly, the unified Merge candidate list can be constructed as {B_{A}, E_{A}, A, C, D}.
4.Insert only one affine candidate in front of the candidate list:
According to the candidate block position, insert the first available affine Merge candidate and then use the HEVC Merge candidate construction method to generate the normal Merge candidates. Accordingly, the unified Merge candidate list can be constructed as {B_{A}, A, B, C, D, E}.
5.Replace the normal Merge candidates by the affine Merge candidates and move the first available affine Merge candidate in front:
If the neighbouring block is an affine coded PU, instead of using the translational MV of the neighbouring block, use the affine Merge candidate that derived from its affine parameter. Accordingly, the unified Merge candidate list can be constructed as {A, B_{A}, C, D, E_{A}}.
6.Replace the normal Merge candidates by the affine Merge candidates and move the first available affine Merge candidate to the front:
If the neighbouring block is an affine coded PU, instead of using the normal MV of the neighbouring block, use the affine Merge candidate that is derived from its affine parameter. After the unified Merge candidate list is generated, move the first available affine Merge candidate in front. Accordingly, the unified Merge candidate list can be constructed as {B_{A}, A, C, D, E_{A}}.
7.Insert one affine candidate in front of the candidate list, and use the remaining affine Merge candidates to replace respective normal Merge candidates:
According to the candidate block position, insert the first available affine Merge candidate. Then according to the HEVC Merge candidate construction order, if the neighboring block is affine coded PU and its affine Merge candidate is not inserted in front, use the affine Merge candidate that is derived from its affine parameter instead of the normal MV of the neighboring block. Accordingly, the Merge candidate list can be constructed as {B_{A}, A, B, C, D, E_{A}}.
8.Insert one affine candidate in front of the candidate list, and insert the remaining affine candidates after respective normal candidates:
According to the candidate block position, insert the first available affine Merge candidate. Then according to the HEVC Merge candidate construction order, if the neighbouring block is affine coded PU and its affine Merge candidate is not inserted in front, insert the normal Merge candidate of the block first and then insert the affine Merge candidate of the block. Accordingly, the unified Merge candidate list can be constructed as {B_{A}, A, B, C, D, E, E_{A}}.
9.Replace the normal Merge candidate if not redundant:
If the neighbouring block is affine coded PU and the derived affine Merge candidate is not already in the candidate list, instead of using the normal MV of the neighbouring block, use the affine Merge candidate that is derived from its affine parameter. If the neighbouring block is affine coded PU and the derived affine Merge candidate is redundant, use the normal Merge candidate.
10.Insert one pseudo affine candidate if the affine Merge candidate is not available:
If none of the neighbouring blocks is affine coded PU, then insert one pseudo affine candidate into the candidate list. The pseudo affine candidate is generated by combining two or three MVs of neighbouring blocks. For example, the v₀ of the pseudo affine candidate can be E, the v₁ of the pseudo affine candidate can be B, and the v₂ of the pseudo affine candidate can be A. In another example, the v₀ of the pseudo affine candidate can be E, the v₁ of the pseudo affine candidate can be C, and the v₂ of the pseudo affine candidate can be D. The locations of neighbouring blocks A, B, C, D and E are shown in FIG. 11.
11.In examples 4, 7 and 8 listed above, the first affine candidate may also be inserted at a pre-defined position in the candidate list. For example, the pre-defined position can be the first position as illustrated in examples 4, 7 and 8. In another example, the first affine candidate is inserted at the fourth position in the candidate list. The candidate list will become {A, B, C, B_{A}, D, E} in example 4, {A, B, C, B_{A}, D, E_{A}} in example 7, and {A, B, C, B_{A}, D, E, E_{A}} in example 8. The pre-defined position can be signalled at a sequence level, picture level or slice level.

After the first round of Merge candidate construction, the pruning process can be performed. For an affine Merge candidate, if all the control points are identical to the control point of one of affine Merge candidates that is already in the list, the affine Merge candidate can be removed.

In ITU-VCEG C1016, the affine flag is conditionally signalled for the PU coded in the Merge mode. When one of the neighbouring blocks is coded in affine mode, the affine flag is signalled. Otherwise, it is skipped. This conditional signalling increases the parsing complexity. Furthermore, only one of the neighbouring affine parameters can be used for the current block. Accordingly, another method of affine Merge mode is disclosed in this invention, where more than one neighbouring affine parameters can be used for Merge mode. Furthermore, in one embodiment, the signalling of affine_flag in Merge mode is not conditional. Instead, the affine parameters are merged into the Merge candidates.

Decoder-Side MV Derivation for Affine Merge or Inter Mode

In ITU VCEG-AZ07 (Chen, et al., “Further improvements to HMKTA-1.0”, ITU Study Group 16 Question 6, Video Coding Experts Group (VCEG), 52nd Meeting: 19-26 Jun. 2015, Warsaw, Poland, Document: VCEG-AZ07), decoder side MV derivation methods are disclosed. In the present invention, decoder side MV derivation is used to generate the control points for affine Merge mode. In one embodiment, a DMVD_affine_flag is signalled. If the DMVD_affine_flag is true, the decoder-side MV derivation is applied to find the MV for the top-left, top-right and the bottom-left sub-blocks, where the size of these sub-blocks is n×n and n is equal to 4 or 8. FIG. 12 illustrates an example of three sub-blocks (i.e., A, B and C) used to derive the MVs for 6-parameter affine model at the decoder side. Also, the top-left and top-right sub-blocks (e.g. A and B in FIG. 12) can be used to derive for the 4-parameter affine model at the decoder side. The decoder-side derived MVP set can be used for affine Inter mode or affine Merge mode. For affine Inter mode, the decoder derived MVP set can be one of the MVP. For affine Merge mode, the derived MVP set can be the three (or two) control points of the affine Merge candidate. For the method of decoder-side MV derivation, the template matching or the bilateral matching can be used. For template matching, the neighbouring reconstructed pixels can be use as the template to find the best matched template in the target reference frame. For example, pixel area a′ can be the template of block A, pixel area b′ can be the template of block B, and pixel area c′ can be the template of block C.

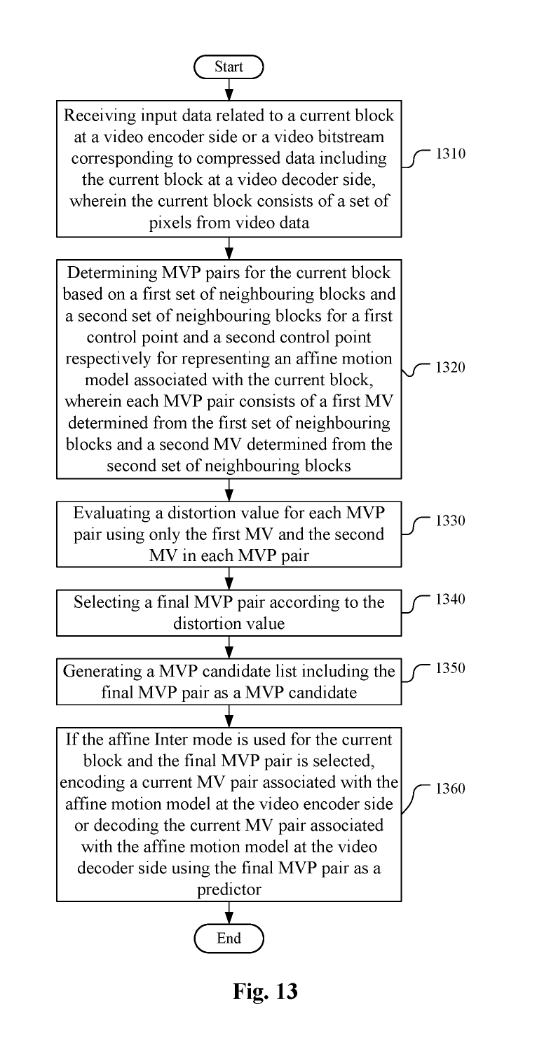

FIG. 13 illustrates an exemplary flowchart for a video coding system with an affine Inter mode incorporating an embodiment of the present invention, where the system uses only two motion vectors at two control points to select a MVP pair. The input data related to a current block is received at a video encoder side or a video bitstream corresponding to compressed data including the current block is received at a video decoder side in step 1310. The current block consists of a set of pixels from video data. As is known in the field, input data corresponding to pixel data are provided to an encoder for subsequence encoding process. At the decoder side, the video bitstream is provided to a video decoder for decoding. MVP pairs for the current block are determined based on a first set of neighbouring blocks and a second set of neighbouring blocks for a first control point and a second control point respectively for representing an affine motion model associated with the current block in step 1320. Each MVP pair consists of a first MV determined from the first set of neighbouring blocks and a second MV determined from the second set of neighbouring blocks. A distortion value for each MVP pair is evaluated using only the first MV and the second MV in each MVP pair in step 1330. As mentioned before, the distortion value is calculated based on three motion vectors at three control points according to an existing method. Therefore, the present method simplifies the process. A final MVP pair is then selected according to the distortion value in step 1340. For example, the final MVP pair may correspond to a MVP pair having the smallest distortion value. A MVP candidate list including the final MVP pair as a MVP candidate is generated in step 1350. If the affine Inter mode is used for the current block and the final MVP pair is selected, the current MV pair associated with the affine motion model is encoded at the video encoder side or decoded at the video decoder side using the final MVP pair as a predictor in step 1360.

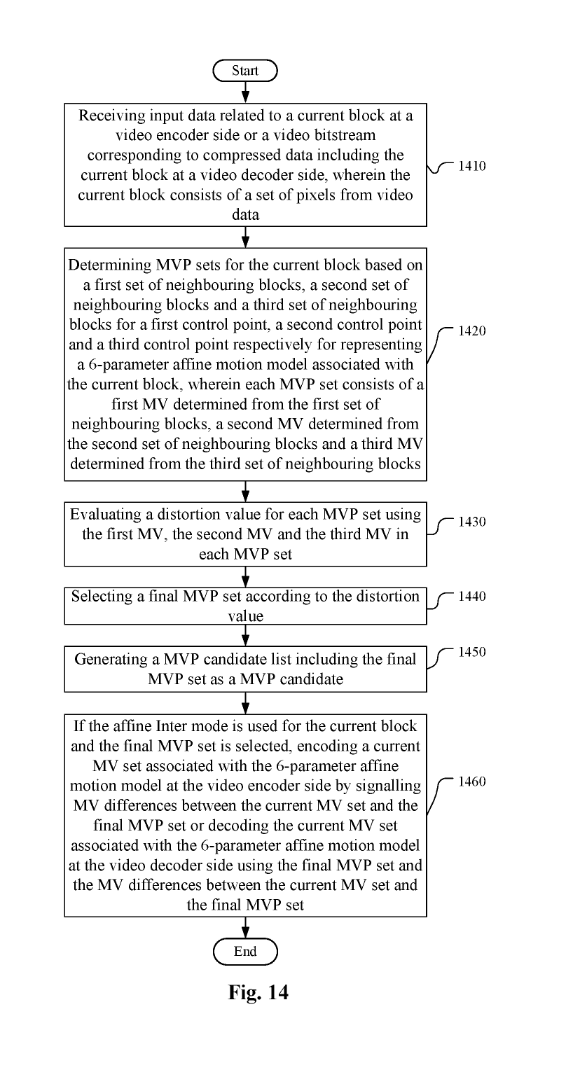

FIG. 14 illustrates an exemplary flowchart for a video coding system with an affine Inter mode incorporating an embodiment of the present invention, where the system uses three motion vectors at three control points to derive a MVP set for blocks coded using 6-parameter affine model. The input data related to a current block is received at a video encoder side or a video bitstream corresponding to compressed data including the current block is received at a video decoder side in step 1410. The current block consists of a set of pixels from video data. MVP sets for the current block are determined based on a first set of neighbouring blocks, a second set of neighbouring blocks and a third set of neighbouring blocks for a first control point, a second control point and a third control point respectively for representing a 6-parameter affine motion model associated with the current block in step 1420. Each MVP set consists of a first MV determined from the first set of neighbouring blocks, a second MV determined from the second set of neighbouring blocks and a third MV determined from the third set of neighbouring blocks. A distortion value for each MVP set is evaluated using the first MV, the second MV and the third MV in each MVP set in step 1430. A final MVP set is selected according to the distortion value in step 1440 and a MVP candidate list including the final MVP set as a MVP candidate is generated in step 1450. If affine Inter mode is used for the current block and the final MVP set is selected, the current MV set associated with the 6-parameter affine motion model is encoded at the video encoder side by signalling the MV differences between the current MV set and the final MVP set or decoded at the video decoder side using the final MVP set and the MV differences between the current MV set and the final MVP set in step 1460.

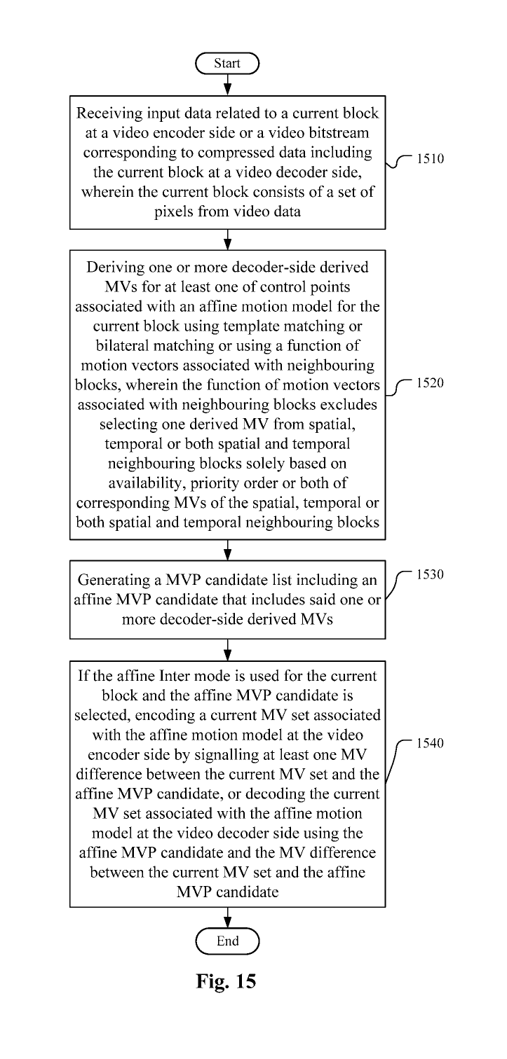

FIG. 15 illustrates an exemplary flowchart for a video coding system with an affine Inter mode incorporating an embodiment of the present invention, where the system generates an AMVP (advanced motion vector predictor) candidate list including a MVP set that includes one or more decoder-side derived MVs. The input data related to a current block is received at a video encoder side or a video bitstream corresponding to compressed data including the current block is received at a video decoder side in step 1510. One or more decoder-side derived MVs are derived for at least one of control points associated with an affine motion model for the current block in step 1520. The decoder-side derived MVs are derived using template matching or bilateral matching or using a function of motion vectors associated with neighbouring blocks. The function of motion vectors associated with neighbouring blocks excludes selecting one derived MV from spatial, temporal or both spatial and temporal neighbouring blocks solely based on availability, priority order or both of corresponding MVs of the spatial, temporal or both spatial and temporal neighbouring blocks. A MVP candidate list including an affine MVP candidate that includes said one or more decoder-side derived MVs is generated in step 1530. If the affine Inter mode is used for the current block and the affine MVP candidate is selected, the current MV set associated with the affine motion model is encoded at the video encoder side by signalling at least one MV difference between the current MV set and the affine MVP candidate, or decoded at the video decoder side using the affine MVP candidate and at least one MV difference between the current MV set and the affine MVP candidate in step 1540.

The flowcharts shown are intended to illustrate an example of video according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of Inter prediction for video coding performed by a video encoder or a video decoder that utilizes motion vector prediction (MVP) to code a motion vector (MV) associated with a block coded with coding modes including affine Inter mode, the method comprising:
receiving input data related to a current block at a video encoder side or a video bitstream corresponding to compressed data including the current block at a video decoder side, wherein the current block consists of a set of pixels from video data;
determining MVP pairs for the current block based on a first set of neighbouring blocks and a second set of neighbouring blocks for a first control point and a second control point respectively for representing an affine motion model associated with the current block, wherein each MVP pair consists of a first MV determined from the first set of neighbouring blocks and a second MV determined from the second set of neighbouring blocks;
evaluating a distortion value for each MVP pair using only the first MV and the second MV in each MVP pair;
selecting a final MVP pair according to the distortion value;
generating a MVP candidate list including the final MVP pair as a MVP candidate; and
if the affine Inter mode is used for the current block and the final MVP pair is selected, encoding a current MV pair associated with the affine motion model at the video encoder side or decoding the current MV pair associated with the affine motion model at the video decoder side using the final MVP pair as a predictor.

2. The method of claim 1, wherein the distortion value (DV) is calculated based on the first MV MVP₀, MVP₀=(MVP₀_{_}ₓ, MVP₀_{_}_{y})) and the second MV (MVP₁, MVP₁=(MVP₁_{_}ₓ, MVP₁_{_}_{y})) in each MVP pair according to DV=|MVP₁_{_}ₓ−MVP₀_{_}ₓ|+|MVP₁_{_}_{y}−MVP₀_{_}_{y}|.

3. The method of claim 1, wherein the distortion value (DV) is calculated based on the first MV (MVP₀, MVP₀=(MVP₀_{_}ₓ, MVP₀_{_}_{y})) and the second MV (MVP₁, MVP₁=(MVP₁_{_}ₓ, MVP₁_{_}_{y}) in each MVP pair by introducing an intermediate MV (MVP₂, MVP₂=(MVP₂_{_}ₓ, MVP₂_{_}_{y})) with (MVP₂_{_}ₓ=−(MVP₁_{_}_{y}−MVP₀_{_}_{y}) * PU_height/PU_d width+MVP₀_{_}ₓ and MVP₂_{_}_{y}=−(MVP₁_{_}ₓ−MVP₀_{_}ₓ)* PU_height/PU_width+MVP₀_{_}_{y}, the DV is calculated according to DV=|(MVP₁_{_}ₓ−MVP₀_{_}ₓ)* PU_height−(MVP₂_{_}_{y}−MVP₀_{_}_{y})* PU_width|+|(MVP₁_{_}_{y}−MVP₀_{_}_{y})* PU_height−(MVP₂_{_}ₓ−MVP₀_{_}ₓ)* PU_width|, wherein PU_height corresponds to height of the current block and PU_width corresponds to width of the current block.

4. The method of claim 1, wherein MVP pair with smaller distortion value is selected as the final MVP pair.

5. An apparatus for Inter prediction of video coding performed by a video encoder or a video decoder that utilizes motion vector prediction (MVP) to code a motion vector (MV) associated with a block coded with coding modes including affine Inter mode, the apparatus comprising one or more electronic circuits or processors arranged to:
receive input data related to a current block at a video encoder side or a video bitstream corresponding to compressed data including the current block at a video decoder side, wherein the current block consists of a set of pixels from video data;
determine MVP pairs for the current block based on a first set of neighbouring blocks and a second set of neighbouring blocks for a first control point and a second control point respectively for representing an affine motion model associated with the current block, wherein each MVP pair consists of a first MV determined from the first set of neighbouring blocks and a second MV determined from the second set of neighbouring blocks;
evaluate a distortion value for each MVP pair using only the first MV and the second MV in each MVP pair;
select a final MVP pair according to the distortion value;
generate a MVP candidate list including the final MVP pair as a MVP candidate; and
if the affine Inter mode is used for the current block, encode a current MV pair associated with the affine motion model at the video encoder side or decode the current MV pair associated with the affine motion model at the video decoder side using the final MVP pair as a predictor.

6. A method of Inter prediction for video coding performed by a video encoder or a video decoder that utilizes motion vector prediction (MVP) to code a motion vector (MV) associated with a block coded with coding modes including affine Inter mode, the method comprising:
receiving input data related to a current block at a video encoder side or a video bitstream corresponding to compressed data including the current block at a video decoder side, wherein the current block consists of a set of pixels from video data;
determining MVP sets for the current block based on a first set of neighbouring blocks, a second set of neighbouring blocks and a third set of neighbouring blocks for a first control point, a second control point and a third control point respectively for representing a 6-parameter affine motion model associated with the current block, wherein each MVP set consists of a first MV determined from the first set of neighbouring blocks, a second MV determined from the second set of neighbouring blocks and a third MV determined from the third set of neighbouring blocks;
evaluating a distortion value for each MVP set using the first MV, the second MV and the third MV in each MVP set;
selecting a final MVP set according to the distortion value;
generating a MVP candidate list including the final MVP set as a MVP candidate; and
if the affine Inter mode is used for the current block and the final MVP set is selected, encoding a current MV set associated with the 6-parameter affine motion model at the video encoder side by signalling MV differences between the current MV set and the final MVP set or decoding the current MV set associated with the 6-parameter affine motion model at the video decoder side using the final MVP set and the MV differences between the current MV set and the final MVP set.

7. The method of claim 6, wherein the first set of neighbouring blocks consists of an upper-left corner block, a left-top block and a top-left block, the second set of neighbouring blocks consists of a right-top block and an upper-right corner block, and the third set of neighbouring blocks consists of a bottom-left block and a lower-left corner block.

8. The method of claim 6, wherein the distortion value (DV) is calculated based on the first MV (MVP₀, MVP₀=(MVP₀_{_}ₓ, MVP₀_{_}_{y})), the second MV (MVP₁, MVP₁=(MVP₁_{_}ₓ, MVP_{1 y})) and the third MV (MVP₂, MVP₂=(MVP_{2 x}, MVP_{2 y})) in each MVP set according to DV=|(MVP₁_{_}ₓ−MVP₀_{_}ₓ)* PU_height−(MVP₂_{_}_{y}−MVP₀_{_}_{y})* PU_width|+|(MVP₁_{_}_{y}−MVP₀_{_}_{y})* PU_height−(MVP₂_{_}ₓ−MVP₀_{_}ₓ)* PU_width|, wherein PU_height corresponds to height of the current block and PU_width corresponds to width of the current block.

9. The method of claim 6, wherein the distortion value (DV) is calculated based on the first MV (MVP₀, MVP₀=(MVP₀_{_}ₓ, MVP₀_{_}_{y})), the second MV (MVP₁, MVP₁=(MVP₁_{_}ₓ, MVP₁_{_}_{y})) and the third MV (MVP₂, MVP₂=(MVP₂_{_}ₓ, MVP₂_{_}_{y})) in each MVP set according to DV=|(MVP₁_{_}ₓ−MVP₀_{_}ₓ)* PU_width−(MVP₂_{_}_{y}−MVP₀_{_}_{y})* PU_height|+|(MVP₁_{_}_{y}−MVP₀_{_}_{y})* PU_width −(MVP₂_{_}ₓ−MVP₀_{_}ₓ)* PU_height|, wherein PU_height corresponds to height of the current block and PU width corresponds to width of the current block.

10. The method of claim 6, wherein the distortion value (DV) is calculated based on the first MV (MVP₀, MVP₀=(MVP₀_{_}ₓ, MVP₀_{_}_{y})), the second MV (MVP₁, MVP₁=(MVP₁_{_}ₓ, MVP₁_{_}_{y})) and the third MV (MVP₂, MVP₂=(MVP₂_{_}ₓ, MVP₂_{_}_{y})) in each MVP set according to DV=|MVP₁−MVP₀| * PU_height+|MVP₂−MVP₀| * PU_width wherein PU_height corresponds to height of the current block and PU_width corresponds to width of the current block.

11. The method of claim 6, wherein the distortion value (DV) is calculated based on the first MV (MVP₀, MVP₀=(MVP₀_{_}ₓ, MVP₀_{_}_{y})), the second MV (MVP₁, MVP₁=(MVP₁_{_}ₓ, MVP₁_{_}_{y})) and the third MV (MVP₂, MVP₂=(MVP₂_{_}ₓ, MVP₂_{_}_{y})) in each MVP set according to DV=|(MVP₁_{_}ₓ−MVP₀_{_}ₓ)* PU_height|+|(MVP₁_{_}_{y}−MVP₀_{_}_{y})* PU_height|+|(MVP₂_{_}ₓ−MVP₀_{_}ₓ)* PU_width|+|(MVP₂_{_}_{y}−MVP₀_{_}_{y})* PU_width|, wherein PU_height corresponds to height of the current block and PU_width corresponds to width of the current block.

12. (canceled)

13. A method of Inter prediction for video coding performed by a video encoder or a video decoder that utilizes motion vector prediction (MVP) to code a motion vector (MV) associated with a block coded with coding modes including affine Inter mode, the method comprising:
receiving input data related to a current block at a video encoder side or a video bitstream corresponding to compressed data including the current block at a video decoder side, wherein the current block consists of a set of pixels from video data;
deriving one or more decoder-side derived MVs for at least one of control points associated with an affine motion model for the current block using template matching or bilateral matching or using a function of motion vectors associated with neighbouring blocks, wherein the function of motion vectors associated with neighbouring blocks excludes selecting one derived MV from spatial, temporal or both spatial and temporal neighbouring blocks solely based on availability, priority order or both of corresponding MVs of the spatial, temporal or both spatial and temporal neighbouring blocks;
generating a MVP candidate list including an affine MVP candidate that includes said one or more decoder-side derived MVs; and
if the affine Inter mode is used for the current block and the affine MVP candidate is selected, encoding a current MV set associated with the affine motion model at the video encoder side by signalling at least one MV difference between the current MV set and the affine MVP candidate, or decoding the current MV set associated with the affine motion model at the video decoder side using the affine MVP candidate and the MV difference between the current MV set and the affine MVP candidate.

14. The method of claim 13, wherein said one or more decoder-side derived MVs correspond to the MVs associated with three control points or two control points for the current block, the MV associated with each control point corresponds to the MV at a respective corner pixel or the MV associated with smallest block containing the respective corner pixel, the two control points are located at upper-left and upper-right corners of the current block and the three control points include an additional location at lower-left corner.

15. The method of claim 13, wherein a decoder-side derived MV flag is signalled to indicate whether said one or more decoder-side derived MVs are used for the current block.

16. The method of claim 13, wherein the function of motion vectors associated with neighbouring blocks corresponds to an average or a median of motion vectors associated with the neighbouring blocks.

17. The method of claim 13, wherein when the template matching is used to derive said one or more decoder-side derived MVs associated with the control points associated with an affine motion model for the current block, the control points are within respective n×n corner sub-blocks and each decoder-side derived MV is derived using a template corresponding to respective n×n neighbouring blocks of each n×n corner sub-block, wherein n is a positive integer.

18. The method of claim 17, wherein the respective n×n corner sub-blocks correspond to an upper-left block and an upper-right block of the current block for a 4-parameter affine model and the respective n×n corner sub-blocks correspond to the upper-left block, the upper-right block and a lower-left block of the current block for a 6-parameter affine model.

19. The method of claim 13, wherein when the template matching is used to derive said one or more decoder-side derived MVs associated with the control points associated with the affine motion model for the current block, the control points correspond to corner pixels of the current block and each decoder-side derived MV is derived using a template corresponding to respective neighbouring pixels within a row, a column or both of each corner pixel of the current block.

20. The method of claim 19, wherein the corner pixels correspond to an upper-left corner pixel and an upper-right corner pixel of the current block for a 4-parameter affine model and the corner pixels correspond to the upper-left corner pixel, the upper-right corner pixel and a lower-left corner pixel of the current block for a 6-parameter affine model.

21. An apparatus for Inter prediction of video coding performed by a video encoder or a video decoder that utilizes motion vector prediction (MVP) to code a motion vector (MV) associated with a block coded with coding modes including affine Inter mode, the apparatus comprising one or more electronic circuits or processors arranged to:
receive input data related to a current block at a video encoder side or a video bitstream corresponding to compressed data including the current block at a video decoder side, wherein the current block consists of a set of pixels from video data;
derive one or more decoder-side derived MVs for at least one of control points associated with an affine motion model for the current block using template matching or bilateral matching or using a function of motion vectors associated with neighbouring blocks, wherein the function of motion vectors associated with neighbouring blocks excludes selecting one derived MV from spatial, temporal or both spatial and temporal neighbouring blocks solely based on availability, priority order or both of corresponding MVs of the spatial, temporal or both spatial and temporal neighbouring blocks;
generate a MVP candidate list including an affine MVP candidate that includes said one or more decoder-side derived MVs; and
if the affine Inter mode is used for the current block and the affine MVP candidate is selected, encode a current MV set associated with the affine motion model at the video encoder side by signaling at least one MV difference between the current MV set and the affine MVP candidate, or decode the current MV set associated with the affine motion model at the video decoder side using the affine MVP candidate and the MV difference between the current MV set and the affine MVP candidate.
